(19) United States
(12) Patent Application Publication
(10) Pub. No.: US 2024/0174369 A1
(43) Pub. Date: May 30, 2024

(54) NACELLE APPARATUS WITH AIR-CONDUCTING DEVICE AND VERTICAL TAKE-OFF AND LANDING AIRCRAFT

(71) Applicant: Rolls-Royce Deutschland Ltd & Co KG, Blankenfelde-Mahlow (DE)

(72) Inventor: Johannes Gabriel Bauer, Eching (DE)

(21) Appl. No.: 18/514,928

(22) Filed: Nov. 20, 2023

(30) Foreign Application Priority Data
Nov. 30, 2022 (DE) 10 2022 131 771.4

(51) Int. Cl. B64D 29/02; B64C 29/00; B64D 33/08

(52) U.S. Cl. CPC B64D 29/02; B64C 29/0033; B64D 33/08; B64D 27/24

(57) ABSTRACT

A nacelle apparatus for a vertical take-off and landing (VTOL) aircraft includes a drive apparatus connected to a wing of the VTOL aircraft via a pylon apparatus and is configured to be pivoted relative to the pylon apparatus about a rotation axis between a propulsion position and a lift position. The nacelle apparatus further includes an air-conducting device having a first inlet opening on the pylon apparatus arranged in the region in which the first air flow strikes the pylon apparatus and a second inlet opening arranged on the nacelle apparatus and/or on the pylon apparatus so that a second air flow is configured to flow in through the second inlet opening in the propulsion position. The air-conducting device further includes an air distribution device with which the flowing air quantities from the first and second inlet openings are configured to be controlled inside the nacelle apparatus.

The present patent document claims the benefit of German Patent Application No. 10 2022 131 771.4, filed Nov. 30, 2022, which is hereby incorporated by reference in its entirety.

### TECHNICAL FIELD

The disclosure relates to a nacelle apparatus and a vertical take-off and landing (VTOL) aircraft.

### BACKGROUND

Aircraft that may take-off and land vertically or vertical take-off and landing (VTOL) aircraft are known in principle. If an electric drive is used as the drive apparatus of such an aircraft, this is also referred to as an eVTOL aircraft. Precisely for using aircraft in the urban sector (UAM: urban air mobility), such aircraft are extremely advantageous.

In this instance, different construction types are used, such as purely rotary wing aircraft or construction types with pivotable wings or pivotable drives.

In a configuration with pivotable drives, for example, they are brought from a lift position into a propulsion position by a pivotable nacelle apparatus (also referred to as gondolas). In this case, the nacelle apparatuses are connected to a wing via a pylon apparatus, wherein the pivoting is carried out about an axis on the housing of the pylon apparatus.

### SUMMARY AND DESCRIPTION

An object of the disclosure is to provide improved nacelle apparatuses that allow efficient distribution of cooling air.

The scope of the present disclosure is defined solely by the appended claims and is not affected to any degree by the statements within this summary. The present embodiments may obviate one or more of the drawbacks or limitations in the related art.

The nacelle apparatus for a vertical take-off and landing aircraft has a drive apparatus, wherein the nacelle apparatus is connected to a wing of the vertical take-off and landing aircraft via a pylon apparatus. The nacelle apparatus and therefore also the drive apparatus may be pivoted relative to the pylon apparatus about a rotation axis between a propulsion position and a lift position.

The nacelle apparatus has an air-conducting device that has at least two inlet openings. The first inlet opening is arranged on the pylon apparatus in the region in which the first air flow, which is conveyed by the drive apparatus in the lift position (primarily vertically downward), strikes the pylon apparatus. As a result, the downwardly orientated first air flow which is conveyed, for example, by a propeller of the drive apparatus, may be collected by the first inlet opening.

The nacelle apparatus further has a second inlet opening arranged on the nacelle apparatus itself and/or on the pylon apparatus so that a second air flow may flow in through the second inlet opening in the propulsion position so that this air flow may also be used as cooling air.

Furthermore, the air-conducting device has an air distribution device with which the flowing air quantities from the first inlet opening and the second inlet opening may be controlled inside the nacelle apparatus. Therefore, the flow of the cooling air in the different operating positions may be adjusted with one device, (e.g., the air distribution device), which saves weight.

In certain examples, the air distribution device may be arranged in a rotatable manner on the nacelle apparatus so that the air distribution device guides the second air flow in the propulsion position from the second inlet opening into the air-conducting device and, in the lift position, guides the first air flow from the first inlet opening into the air-conducting device. By rotating the nacelle apparatus about the rotation axis, the air distribution device is also rotated, wherein, in both positions, the air distribution device adjoins the air-conducting device (for example, channels, pipes, etc.) so that the inflowing air flows may be guided into the interior. Consequently, apart from the nacelle apparatus, which is movable in any case, no additional moving parts are necessary.

For efficient reception of the air flows, the air distribution device may be orientated in one embodiment in the propulsion position so that the second inlet opening is orientated at least partially in a flight direction. As a result, the second inlet opening may receive air that is conveyed by the propeller in a propulsion direction. The inlet opening may consequently be inclined perpendicularly or also in an inclined manner relative to the flight direction as long as the free cross section may receive air from the flight direction.

In another embodiment, the air distribution device may be orientated in the lift position so that the air distribution device may be connected to a supply channel for the first air flow from the first inlet opening. As a result, additional lines for air distribution in the nacelle apparatus are saved, which leads to a reduction in weight.

In this case, the air distribution device may be configured at least partially in a tubular manner or may be in the form of a National Advisory Committee for Aeronautics (NACA) inlet so that, in both cases, an efficient inflow into the air-conducting device of the nacelle apparatus is possible.

If the drive apparatus has a propeller that has a rotation face during operation, the first inlet opening may be located in the region of the perpendicular projection of the rotation face onto the upper side of the pylon apparatus. As a result, the selectively downwardly conveyed air flow strikes the pylon apparatus with the first inlet opening. In particular, the first inlet opening may be arranged vertically under the region of the rotation face, in which the total pressure of the air conveyed by the propeller is at a maximum. As a result, the conveyed air flow would be collected efficiently by the first inlet opening.

Furthermore, the air flows introduced by the drive apparatus and via the first inlet opening and/or via the second inlet opening may be guided to the drive apparatus and/or to an electric motor as cooling air.

For efficient conveying of the air in the propulsion position, the second inlet opening may be at least partially in the form of an NACA inlet.

The object of the disclosure is also achieved by a vertical take-off and landing aircraft as described herein. In this case, the drive unit may be coupled to a pivoting apparatus that is in the form of a lever gear mechanism, in particular to a hydraulically, electrically, or pneumatically driven lever gear mechanism.

### BRIEF DESCRIPTION OF THE DRAWINGS

Exemplary embodiments are explained in connection with the Figures. In the figures:

FIG. 1 depicts a schematic illustration of a first embodiment of a nacelle apparatus in a first position (e.g., propulsion position).

FIG. 2 depicts a schematic illustration of the first embodiment of the nacelle apparatus according to FIG. 1 in a second position (e.g., lift position).

FIG. 3 depicts a schematic illustration of the first embodiment according to FIGS. 1 and 2 with an illustration of the flows in an air-conducting device.

FIG. 4 depicts a schematic illustration of a second embodiment of a nacelle apparatus in a first position (e.g., propulsion position).

FIG. 5 depicts a schematic illustration of the second embodiment of the nacelle apparatus according to FIG. 4 in a second position (e.g., lift position).

FIG. 6 depicts a schematic illustration of the second embodiment according to FIGS. 4 and 5 with an illustration of the flows in an air-conducting device.

### DETAILED DESCRIPTION

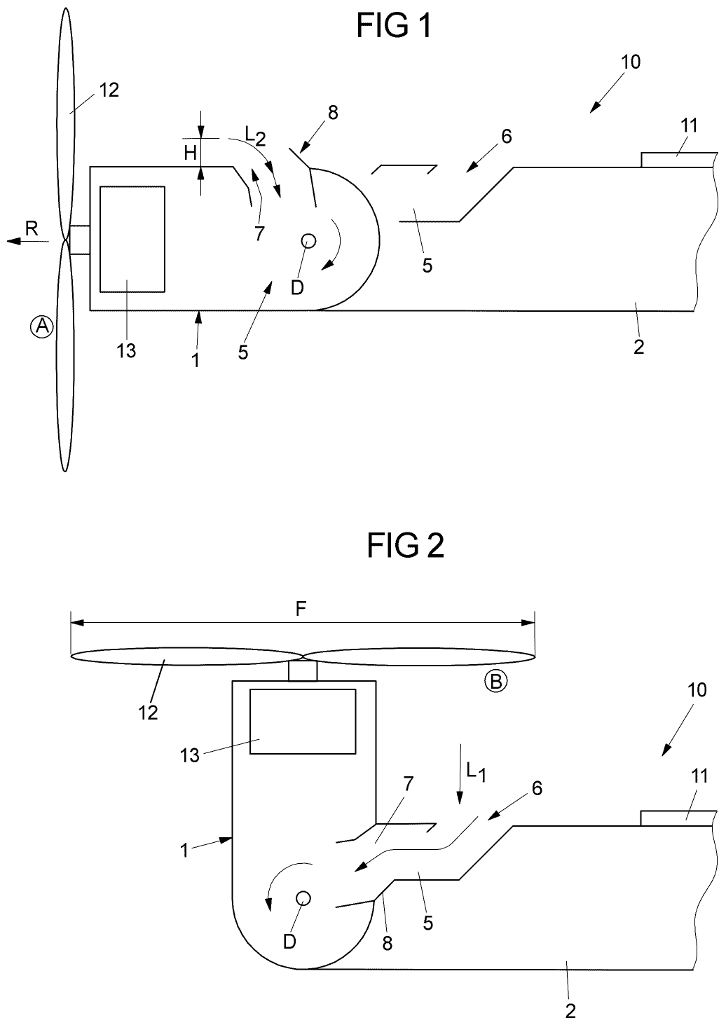

FIG. 1 depicts a schematic illustration of an embodiment of a nacelle apparatus 1 which may be pivoted about a rotation axis D from a propulsion position A (as illustrated in FIG. 1) into a lift position B (see FIG. 2). A drive apparatus 12 with a propeller is arranged on the nacelle apparatus 1.

The pivoting of the nacelle apparatus 1 (and therefore also of the drive apparatus 12) is also reversible so that the nacelle apparatus 1 may be pivoted from the lift position B into the propulsion position A. As a result, this embodiment is particularly suitable for a vertical take-off and landing aircraft 10.

In the embodiment illustrated here, the nacelle apparatus 1 is pivotably arranged on a pylon apparatus 2, which is arranged in turn on a wing 11 of the vertical take-off and landing aircraft 10 (not completely illustrated here).

The rotation axis D is located in the embodiment illustrated here inside the pylon apparatus 2 so that the nacelle apparatus 1 may rotate with the rear or lower portion thereof inside the pylon apparatus 2.

Arranged inside the nacelle apparatus 1 and the pylon apparatus 2 is an air-conducting device 5, with which cooling air L₁, L₂ may be guided more efficiently and particularly in an adaptive manner from the environment of the vertical take-off and landing aircraft 10, for example, to an electric motor 13 of the drive unit 12.

The different types of air conducting in the different positions A, B are set out below.

In this instance, the nacelle apparatus 1 has, in the rear region (when viewed in the propulsion position) about the rotation axis D, an air distribution device 8 arranged on the wall of the nacelle apparatus 1. The air distribution device 8 is consequently pivotable with the nacelle apparatus 1 about the rotation axis D. This is visible, for example, in FIG. 2 because it is located in a state pivoted through 90° in the clockwise direction at that location.

In the propulsion position according to FIG. 1, the air distribution device 8 projects by a height H out of the wall of the nacelle apparatus 1 and is inclined in the flight direction. This means that a second inlet opening 7 is orientated at least partially in the flight direction.

As a result, a second air flow L₂ may be guided from the environment of the vertical take-off and landing aircraft 10 via the second inlet opening 7 into the air-conducting device 5 inside the nacelle apparatus 1.

In this case, the air distribution device 8 may have a piece of pipe that is curved in the direction of the flight direction. However, it may also be at least partially in the form of an NACA inlet, via which the second air flow L₂ may be introduced into the interior of the nacelle apparatus 1 or the pylon apparatus 2.

In the lift position B (see FIG. 2), the propeller of the drive apparatus 12 is orientated upward so that (during operation) a rotation face F of the propeller is partially located above the pylon apparatus 2. A first inlet opening 6 is arranged in the region of the perpendicular projection of the rotation face F in the surface of the pylon apparatus 2. As a result, the air flow L₁ conveyed by the propeller also strikes the first inlet opening 6 so that the air flow L₁ may be guided into the air-conducting device 5 inside the pylon apparatus 2.

In this case, the air-conducting device 5 has a channel that adjoins the air distribution device 8 in the lift position B, and which has now been pivoted in this direction. As a result, the air may be introduced inside the nacelle apparatus 5 and may also cool, for example, the electric motor 13 in this flight phase.

By using a nacelle apparatus 1 with a jointly pivotable air distribution device 8, weight is saved and the high cooling requirements in the event of lift may be complied with. The air conveyed downward by the propeller may be used efficiently as cooling air, which is important because in this position travel wind is scarcely available as cooling air.

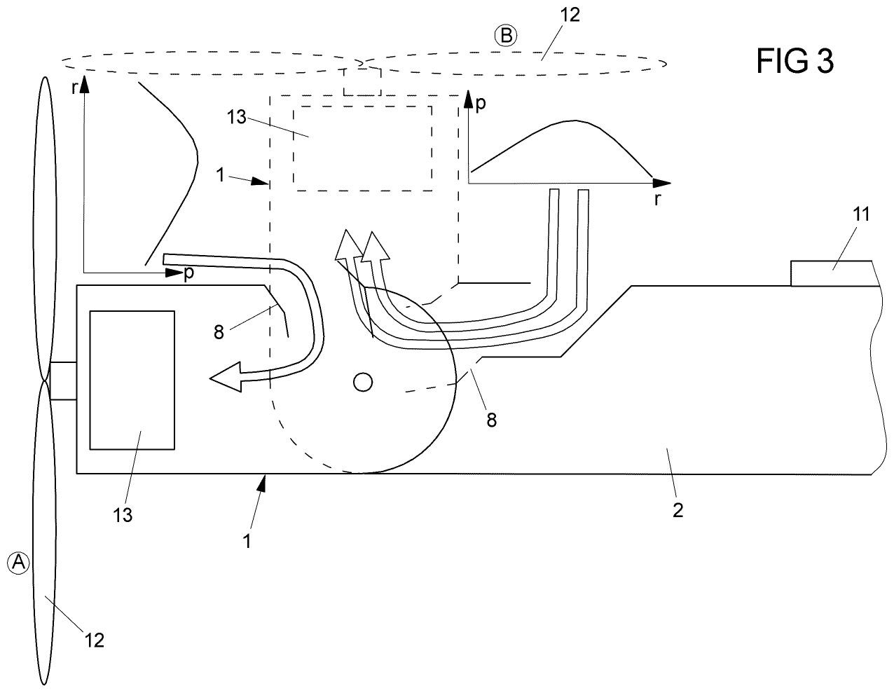

In this case, specific pressure relationships that are illustrated schematically in FIG. 3 are present, wherein the two positions A, B of the nacelle apparatus 1 are illustrated in a superimposed manner here.

The coordinate system under the propeller in the lift position B indicates on the x axis the radial position of the propeller, on the y axis the total pressure in the VTOL flight is indicated. It may be seen that a maximum of the total pressure is in a specific radial region of the rotation face F.

FIG. 3 also illustrates the pressure relationships in the propulsion position A in the form of a coordinate system, wherein the axes are illustrated here in a state pivoted through 90°. The x axis shows the total pressure of the air conveyed by the propeller, and the y axis indicates the radial position of the propeller. The maximum of the total pressure is (similarly to the lift position) in the region between the hub of the propeller and the tip of the propeller. Because the second inlet opening 7 is near the hub of the propeller here, the height H (see FIG. 1) at which the second inlet opening 7 projects out of the housing of the nacelle apparatus 1 is configured accordingly so that, in this position, a sufficiently great second air flow L₂ may flow in.

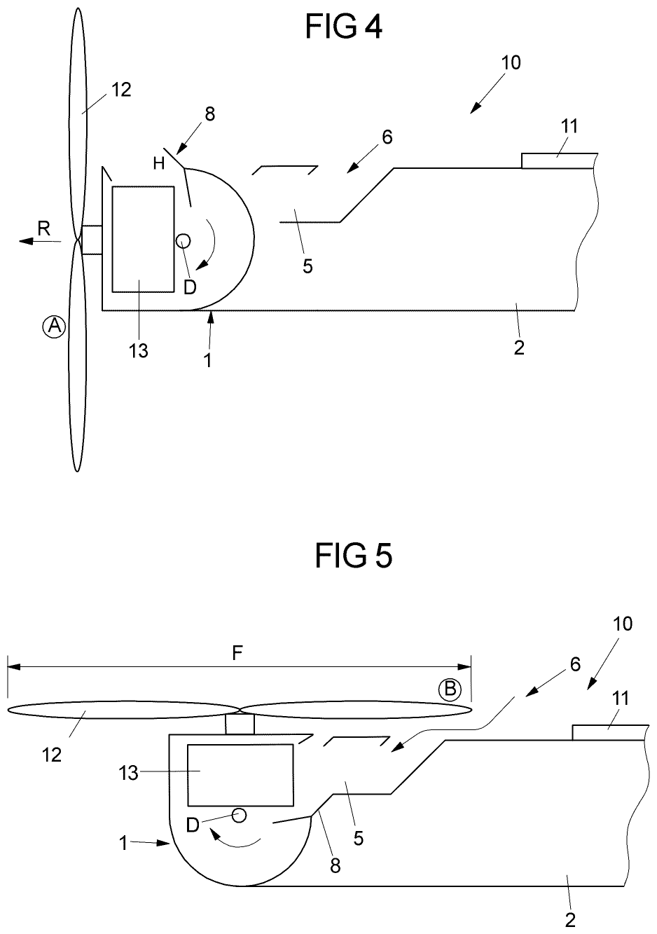

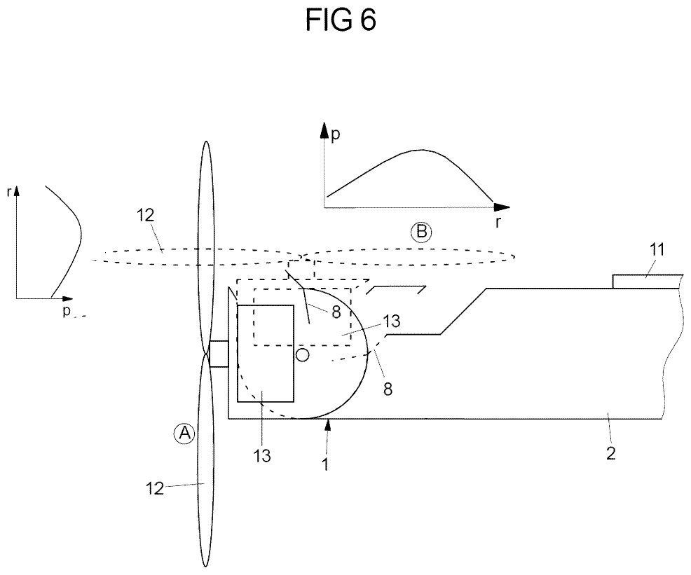

In FIGS. 4 to 6, a modification of the first embodiment according to FIGS. 1 to 3 is illustrated as a second embodiment. In the second embodiment, the pivotable portion of the nacelle apparatus 1 is configured to be shorter so that the inlet for the air flow L₂ is arranged directly above the electric motor 13. For reasons of clarity, the air flows L₁, L₂ in FIGS. 4 to 6 are not illustrated because they extend in the second embodiment similarly to the first embodiment.

It should be understood that the disclosure is not limited to the embodiments described above, and various modifications and improvements may be made without departing from the concepts described here. It is furthermore to be noted that any of the features described may be used separately or in combination with any other features, provided that they are not mutually exclusive. The disclosure extends to and includes all combinations and sub-combinations of one or more features that are described here. If ranges are defined, these ranges therefore include all the values within these ranges as well as all the partial ranges that lie within a range.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

### LIST OF REFERENCE SIGNS

1 Nacelle apparatus
2 Pylon apparatus
5 Air-conducting device
6 First inlet opening
7 Second inlet opening
8 Air distribution device
10 Vertical take-off and landing aircraft
11 Wing
12 Drive apparatus, rotor
13 Electric motor
A propulsion position of the drive apparatus
B Lift position of the drive apparatus
D Rotation axis of the pivotable nacelle apparatus
F Rotation face of the propeller
L₁ First conveyed air flow
L₂ Second conveyed air flow
R Flight direction

1. A nacelle apparatus for a vertical take-off and landing aircraft, the nacelle apparatus comprising:
a drive apparatus connected to a wing of the vertical take-off and landing aircraft via a pylon apparatus, wherein the drive apparatus is configured to be pivoted relative to the pylon apparatus about a rotation axis between a propulsion position and a lift position; and
an air-conducting device comprising a first inlet opening on the pylon apparatus, wherein the first inlet opening is arranged in a region in which a first air flow, which is conveyed by the drive apparatus in the lift position, strikes the pylon apparatus,
wherein the air-conducting device further comprises a second inlet opening arranged on the nacelle apparatus and/or on the pylon apparatus such that a second air flow is configured to flow in through the second inlet opening in the propulsion position,
wherein the air-conducting device further comprises an air distribution device with which the first air flow from the first inlet opening and the second air flow from the second inlet opening are configured to be controlled inside the nacelle apparatus.

2. The nacelle apparatus of claim 1, wherein the air distribution device is arranged in a rotatable manner on the nacelle apparatus so that the air distribution device guides the second air flow in the propulsion position from the second inlet opening into the air-conducting device and, in the lift position, guides the first air flow from the first inlet opening into the air-conducting device.

3. The nacelle apparatus of claim 2, wherein the second inlet opening is configured to be orientated at least partially in a flight direction when the air distribution device is orientated in the propulsion position.

4. The nacelle apparatus of claim 3, wherein the air distribution device is configured to be connected to a supply channel for the first air flow from the first inlet opening when the air distribution device is orientated in the lift position.

5. The nacelle apparatus of claim 4, wherein that the air distribution device is configured at least partially in a tubular manner or is in a form of a National Advisory Committee for Aeronautics (NACA) inlet.

6. The nacelle apparatus of claim 5, wherein the drive apparatus has a propeller that has a rotation face during operation, and
wherein the first inlet opening is located in a region of a perpendicular projection of the rotation face onto an upper side of the pylon apparatus.

7. The nacelle apparatus of claim 6, wherein the first inlet opening is arranged vertically under a region of the rotation face in which a total pressure of air conveyed by the propeller is at a maximum.

8. The nacelle apparatus of claim 1, wherein the second inlet opening is configured to be orientated at least partially in a flight direction when the air distribution device is orientated in the propulsion position.

9. The nacelle apparatus of claim 1, wherein the air distribution device is configured to be connected to a supply channel for the first air flow from the first inlet opening when the air distribution device is orientated in the lift position.

10. The nacelle apparatus of claim 1, wherein that the air distribution device is configured at least partially in a tubular manner or is in a form of a National Advisory Committee for Aeronautics (NACA) inlet.

11. The nacelle apparatus of claim 1, wherein the drive apparatus has a propeller that has a rotation face during operation, and
wherein the first inlet opening is located in a region of a perpendicular projection of the rotation face onto an upper side of the pylon apparatus.

12. The nacelle apparatus of claim 11, wherein the first inlet opening is arranged vertically under a region of the rotation face in which a total pressure of air conveyed by the propeller is at a maximum.

13. The nacelle apparatus of claim 1, wherein the first air flow and/or the second air flow are configured to be guided to the drive apparatus and/or to an electric motor as cooling air.

14. The nacelle apparatus of claim 1, wherein the second inlet opening is at least partially in a form of a National Advisory Committee for Aeronautics (NACA) inlet.

15. A vertical take-off and landing aircraft comprising:
at least one pylon apparatus on a wing,
wherein the at least one pylon apparatus has an air-conducting device comprising:
a first inlet opening on the at least one pylon apparatus, wherein the first inlet opening is arranged in a region in which a first air flow, which is conveyed by a drive apparatus in a lift position, strikes the at least one pylon apparatus;
a second inlet opening arranged on a nacelle apparatus and/or on the at least one pylon apparatus such that a second air flow is configured to flow in through the second inlet opening in a propulsion position; and
an air distribution device with which the first air flow from the first inlet opening and the second air flow from the second inlet opening are configured to be controlled inside the nacelle apparatus.

16. The vertical take-off and landing aircraft of claim 15, wherein the drive apparatus is coupled to a pivoting apparatus in a form of a lever gear mechanism.

17. The vertical take-off and landing aircraft of claim 16, wherein the lever gear mechanism is a hydraulically driven lever gear mechanism, an electrically driven lever gear mechanism, or a pneumatically driven lever gear mechanism.
